(19) United States
(12) Patent Application Publication
(10) Pub. No.: US 2007/0219981 A1
(43) Pub. Date: Sep. 20, 2007

(54) Electronic conference system, electronic conference support method, electronic conference support device, and conference server

(76) Inventors: Motoyuki Takaai, Ashigarakami-gun (JP); Yuichi Ueno, Ashigarakami-gun (JP); Eriko Tamaru, Yokohama-shi (JP); Hitoshi Abe, Tokyo (JP)

Correspondence Address: Matthew E. Connors;Gauthier & Connors LLP, Suite 2300, 225 Franklin Street, Boston, MA, 02110, US

(21) Appl. No.: 11/522,884

(22) Filed: Sep. 18, 2006

(30) Foreign Application Priority Data
Mar. 2, 2006 (JP) 2006-056766

(51) Int. Cl. G06F 17/30; G06F 15/16

(52) U.S. Cl. 707/5; 709/204

(57) ABSTRACT

A conference server computer to which a display device is connected has a unit that acquires attribute information which is input and designated with respect to a drawing object contained in a screen image displayed on the display device, a controller that processes the drawing object in accordance with the attribute information, and a unit that transmits the attribute information acquired to an electronic conference control device. An electronic conference control device has a unit that manages, as a drawing object, a partial screen image forming a portion of a screen image when the screen data are displayed, a processor that receives attribute information transmitted from one of the conference server computers, and a processor that notifies the attribute information with respect to the drawing object to a conference server computer other than the conference server computer in which the attribute information is input and designated.

### BACKGROUND

1. Technical Field

The present invention relates to an electronic conference system having conference server computers to which display devices provided in conference rooms are connected, and, in particular, to handling of display or the like of a partial screen image which is a part of a screen image to be displayed on a display device.

2. Related Art

Recently, many companies have introduced electronic conference systems in order to improve efficiency of conferences. An electronic conference system of the related art includes a touch panel display device placed at a position which can be seen from all participants of the conference in a conference room, and a conference server computer which controls display on the touch panel display device. In an electronic conference which uses the electronic conference system having such a structure, during the conference, processes such as common recognition of the subject to be discussed, writing on the display screen image, etc., by the participants of the conference are executed by reference to displayed contents on the touch panel display device. In addition, by connecting, through a network, conference server computers provided at multiple sites to realize identical displays on all touch panel display devices, a common subject can be discussed at multiple sites.

When the participants are discussing the common subject at multiple sites, there may arise cases where it is desired to have different display content at a site of the participants (self-site) and other sites, depending on a review item or the like; for example, when it is desired to not show, on the touch panel display devices of the other sites, a part of contents displayed on the touch panel display device of the self-site.

### SUMMARY

According to one aspect of the present invention, there is provided an electronic conference system having a plurality of conference servers to which a display is connected, and an electronic conference control device, wherein the conference server comprises, an attribute acquiring unit that acquires attribute information which is designated with respect to a drawing object contained in a screen image displayed on the connected display, a screen data process controller that processes the drawing object in accordance with the acquired attribute information, and an attribute information transmitting unit that transmits the acquired attribute information to the electronic conference control device, and the electronic conference control device comprises, a screen data management unit that manages information related to screen image commonly displayed on the plurality of displays, a drawing object management unit that manages a portion of a screen image as a drawing object, an attribute designation processor that receives attribute information transmitted from the attribute information transmitting unit of one of the plurality conference servers, and an attribute notification processor that notifies the received attribute information with respect to the drawing object to a conference server other than the conference server in which the attribute information is designated.

### BRIEF DESCRIPTION OF THE DRAWINGS

These and other aspects of the disclosure will become apparent from the following description read in conjunction with the accompanying drawings, wherein the same reference numerals have been applied to like parts and in which:

FIG. 1 is an overall structural diagram schematically showing an exemplary embodiment of an electronic conference system according to the present invention;

FIG. 2 is a block structural diagram of an electronic conference system according to an exemplary embodiment of the present invention;

FIG. 3 is a diagram exemplifying a data structure of information stored in a drawing object information storage in an exemplary embodiment of the present invention;

FIG. 4 is a diagram for explaining a user operation for creating a drawing object according to an exemplary embodiment of the present invention;

FIGS. 5A, 5B, 5C, and 5D are diagrams for explaining handling of the drawing object when an attribute of “unshared” is set for the drawing object;

FIG. 6 is a flowchart showing an attribute setting process according to an exemplary embodiment of the present invention;

FIGS. 7A, 7B, 7C, and 7D are diagrams for explaining other forms of use when an attribute of “unshared” is set for a drawing object in an exemplary embodiment of the present invention;

FIGS. 8A and 8B are diagrams for explaining handling of a drawing object when an attribute of “editing prohibition” is set for the drawing object in an exemplary embodiment of the present invention;

FIGS. 9A, 9B, and 9C are diagrams for explaining handling of a drawing object when an attribute of “front display” is set for the drawing object in an exemplary embodiment of the present invention;

FIGS. 10A, 10B, and 10C are diagrams for explaining handling of a drawing object when an attribute of “enlargement/reduction” is set for the drawing object in an exemplary embodiment of the present invention;

FIGS. 11A, 11B, and 11C are diagrams for explaining handling of a drawing object when an attribute of “always display” is set for the drawing object in an exemplary embodiment of the present invention; and

FIGS. 12A and 12B are diagrams for explaining handling of a drawing object when an attribute of “transparent” is set for the drawing object in an exemplary embodiment of the present invention.

### DETAILED DESCRIPTION

Exemplary embodiments of the present invention will now be described by reference to the drawings.

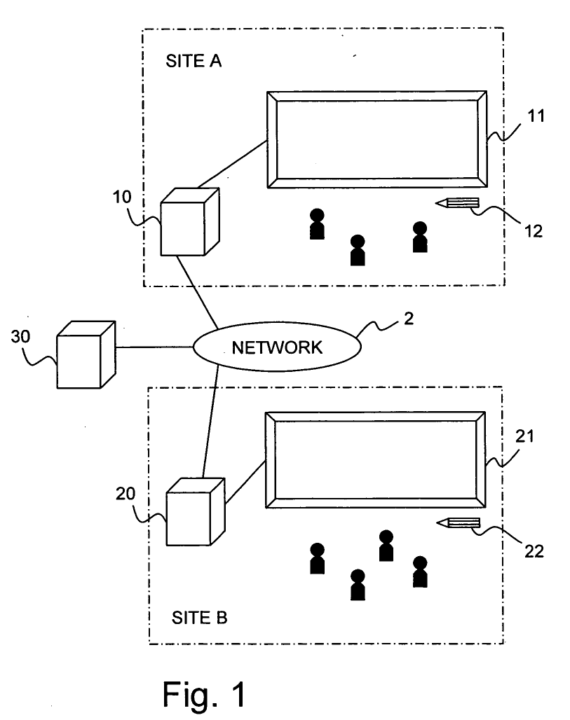

FIG. 1 is an overall structural diagram schematically showing an exemplary embodiment of an electronic conference system according to the present invention. FIG. 1 shows a conference information management server 30, conference server computers (hereinafter simply referred to as “conference servers”) 10 and 20 provided at sites A and B, and touch panel display devices 11 and 21. The conference information management server 30 controls the overall electronic conference carried out by means of the electronic conference system of the exemplary embodiment and centrally stores and manages information necessary for carrying out the electronic conference, such as management information of conference rooms, user information related to individuals participating in the conference, and information related to a conference body for identifying the conference of which a user is a member. The conference servers 10 and 20 are connected via a network 2 for exchange of information with other servers and cooperate to control display on the touch panel display devices 11 and 21 connected to the conference servers 10 and 20. The touch panel display devices 11 and 21 are respectively connected to conference rooms and are placed at positions which can be seen by the conference participants in the conference rooms. By cooperation of the conference servers 10 and 20 to control display on the touch panel display devices 11 and 21 to which the conference servers 10 and 20 are connected, respectively, a same screen image can be displayed on the touch panel display devices 11 and 21 of all sites, and the participants of the conference at the sites A and B can discuss a common subject displayed on the screen. In addition, it is possible to write on the touch panel display devices 11 and 21 with respect to a screen image which is being displayed, and participants in the conference can hold discussions while writing on the display screens of the touch panel display devices 11 and 21 as necessary by means of electronic pens 12 and 22. Because of a basic function of the electronic conference system, the information written at one of the sites is displayed on the touch panel display devices of the other sites, and, thus, the display contents at the sites are basically the same. However, when a function provided by the exemplary embodiment is utilized, different screen images can be displayed for different sites, and, thus, the electronic conference system is not limited to the above-described configuration.

For the sake of simplicity, FIG. 1 only shows two conference servers 10 and 20, but the present invention is not limited to such a configuration, and a system can be constructed by connecting a larger number of conference servers via a network. The network 2 is realized by various communication networks such as LAN provided within an office which uses the electronic conference system. The structure itself of the network, however, is not the main point of the exemplary embodiment, and, therefore, the network is illustrated in a simplified manner.

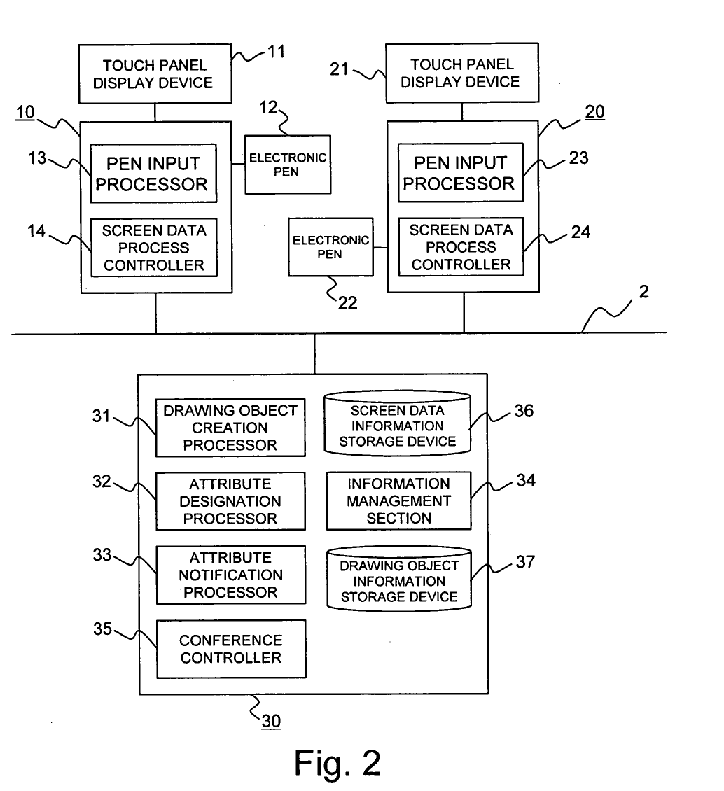

FIG. 2 is a block structural diagram of an electronic conference system according to the exemplary embodiment. The conference server 10 and the conference server 20 in the exemplary embodiment have identical structures, and, therefore, the structure will be explained exemplifying the conference server 10.

The conference server 10 has a pen input processor 13 and a screen data process controller 14. The pen input processor 13 inputs a content operated by the participant of the conference on the touch panel display device 11 by means of the electronic pen 12. More specifically, the conference participants use the electronic pen 12 to write (draw), to point to a certain position on the screen, or to create a drawing object, and the pen input processor 13 inputs information necessary for identifying a type of the operation content, a contact position of the tip of the pen on the touch panel display device 11, etc. The screen data process controller 14 controls display of a screen image to the touch panel display device 11, controls display of the touch panel display device 11 such as creation of a screen image through synthesis of a screen image and a drawing object, in particular, controls display with respect to the drawing object in the exemplary embodiment, and applies a control process. The processing functions in the sections 13 and 14 of the conference server 10 are realized by a cooperation of a computer constructing the conference server 10 and the electronic conference support program operating on a CPU equipped in the computer.

The conference information management server 30 has a drawing object creation processor 31, an attribute designation processor 32, an attribute notification processor 33, an information management section 34, a conference controller 35, a screen data information storage device 36, and a drawing object information storage device 37. The drawing object creation processor 31 creates a drawing object in accordance with a drawing object creation operation by a conference participant at one site. In the explanation of these structures, it is assumed that, for convenience of the explanation, a conference participant at a site A operates. The attribute designation processor 32 receives an attribute which is input and designated by a user with respect to a drawing object contained on a screen image displayed on the touch panel display device 11. The attribute notification processor 33 transmits the attribute with respect to the drawing object received by the attribute designation processor 32 to the conference server 20 other than the conference server 10 in which the attribute is input and designated. In the exemplary embodiment, the attribute information is not directly transmitted to the conference server 20, but rather is temporarily stored in the drawing object information storage 37. The conference server 20 acquires the attribute information by reading from the drawing object information storage 37. The screen data information storage 36 stores information related to screen data displayed on the touch panel display devices 11 and 21. The drawing object is a partial screen image forming a portion of a screen image and may be formed in advance or created by the drawing object creation processor 31 in accordance with a user operation. The drawing object information storage 37 stores information related to the drawing object. The information management section 34 updates and reads information stored in the storage devices 36 and 37 in accordance with a request and manages information to be handled by the storage devices 36 and 37, such as, for example, storing new information. The conference controller 35 controls the overall electronic conference in accordance with the user operation such as, for example, startup of the sections 31-34. The processing functions of the sections 31-35 of the conference information management server 30 are realized by cooperation of a computer constituting the conference information management server 30 and an electronic conference support program operated on a CPU equipped in the computer. The storage devices 36 and 37 are realized by an external storage device such as, for example, an HDD (hard disk drive).

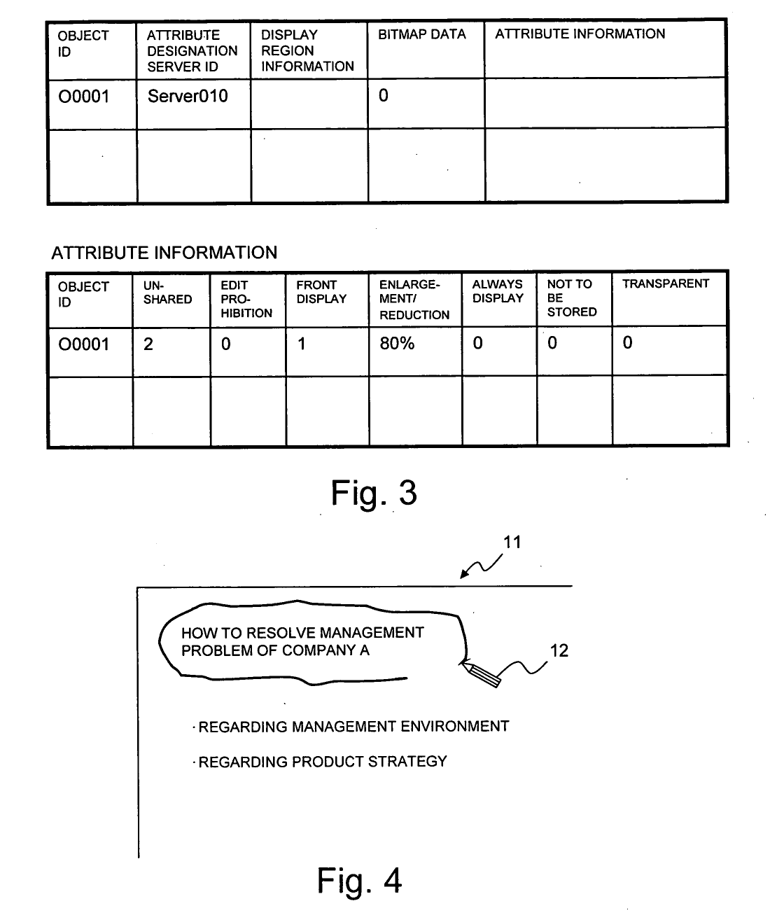

FIG. 3 is a diagram exemplifying a data structure of information stored in the drawing object information storage 37 in the exemplary embodiment. An object ID is assigned to the drawing object to be stored in order to distinguish the drawing object from other drawing objects. An attribute designation server ID, display region information, bitmap data, and various attribute information are stored in correspondence to the drawing object ID. In the attribute designation server ID, the server ID of the conference server used by the user who sets the attribute for the drawing object as will be described later is used. In the exemplary embodiment, when a user uses the electronic pen 12 to form a closed space on a screen image displayed on the touch panel display device 11, the portion of the screen image contained in the closed space is handled as the drawing object and the display region information is the information for identifying the display position of the closed space on the screen image. The bitmap data are the actual data contained in the closed space. Because the closed space is formed by connecting line segments, the display region information can be represented in coordinate data of ends of the each line segments and shape of the each line segment. Alternatively, it is also possible to determine a quadrangular shape surrounding the closed space and set the coordinate data of the corners of the quadrangular shape.

In the exemplary embodiment, attributes such as “unshared”, “edit prohibition”, “front display”, “enlargement/reduction”, “always display”, “not to be stored”, and “transparent” can be set and changed for each drawing object. The attributes and the attribute values set for the attributes will be described in detail later.

Next, an operation in the exemplary embodiment will be described. Creation of the drawing object will first be described and, then, setting of an attribute for the drawing object which is a characteristic of the exemplary embodiment will be described.

FIG. 4 is a diagram for explaining a user operation for creating a drawing object in the exemplary embodiment. Here, an example case is considered in which a conference participant who is present at a site A creates a drawing object.

The conference participant first selects a creation mode of the drawing object. The conference participant can select a desired mode through, for example, operation of a mode switching switch provided on the electronic pen 12, the use of an electronic pen for creation mode from among electronic pens prepared corresponding to the modes, etc. When the conference controller 35 judges that a creation mode of the drawing object is selected by detecting the user operation, the drawing object creation processor 31 is started by the conference controller 35. When the conference participant creates a closed space on the screen by drawing a closed curve using the electronic pen 12, the drawing object creation processor 31 extracts the screen image contained in the closed space and acquires bitmap data. In addition, the drawing object creation processor 31 identifies a display position within a closed space on the screen image and creates display region information. Then, the drawing object creation processor 31 assigns a drawing object ID to the created drawing object, acquires a server ID of the conference server 10 in which the drawing object is created, and stores the display region information and the bitmap data in correspondence to each other in the drawing object information storage 37. In this manner, the drawing object creation processor 31 creates information related to the created drawing object in accordance with the conference participant's creation operation of the drawing object, and stores the information in the drawing object information storage device 37.

The screen data process controllers 14 and 24 acquire information related to the drawing object stored in the drawing object information storage 37 by requesting the information management section 34 for the information, newly create a screen image by synthesizing, based on the acquired information related to the drawing object, the drawing object and the screen image which is being displayed, and display the screen image on the touch panel display devices 11 and 21, respectively.

In the electronic conference system, as described above, the conference servers 10 and 20 provided at multiple sites are connected, and the same screen image can be displayed on the touch panel display devices 11 and 21 at these sites, through cooperation of the conference servers 10 and 20 and the conference information management server 30. When a conference participant at a site B writes on the touch panel display device 21 to create a drawing object, the same screen image is displayed on the touch panel display devices 11 and 21, similar to the above-described process.

From the state in which the display contents are identical at all sites, an attribute is set for the drawing object, which is a characteristic process of the exemplary embodiment. This process will now be described. In addition, the state of the drawing object after the attribute has been set will also be described. In the exemplary embodiment, because all conference servers 10 and 20 have the same structure, the process to be described can be executed from any of the conference servers 10 and 20. Here, unless otherwise described, a case is described in which a conference participant at the site A sets an attribute for a drawing object.

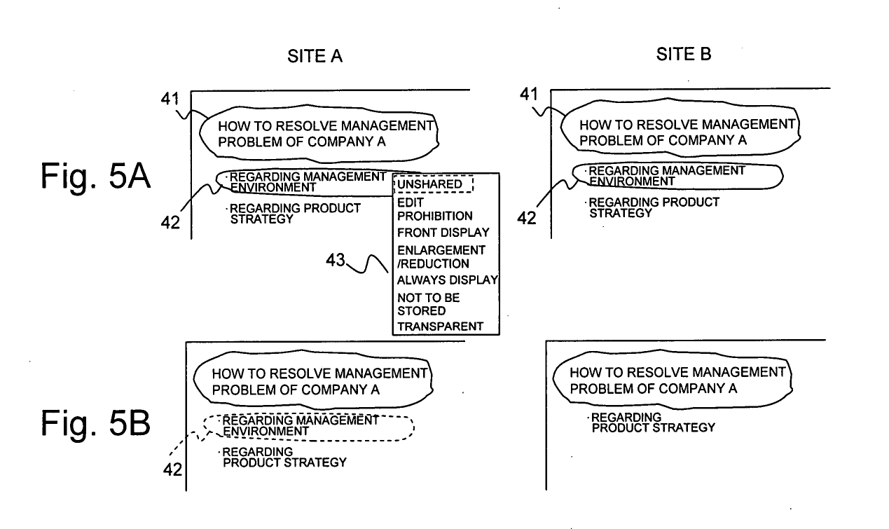

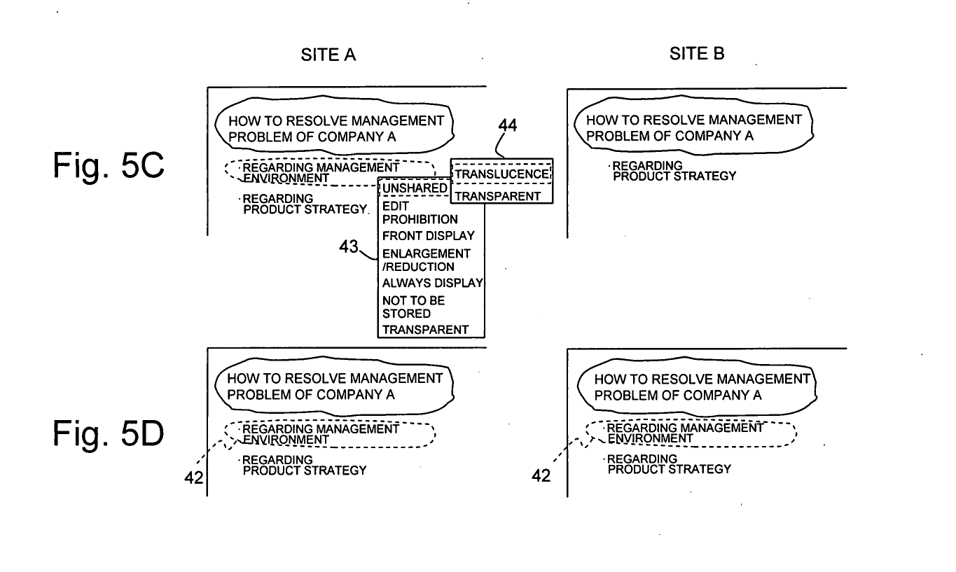

FIG. 5 is a diagram for explaining handling of a drawing object when an attribute of “unshared” is set for the drawing object and shows an example screen display showing primary portions of the touch panel display devices 11 and 21 at the sites. As described above, in the exemplary embodiment, the display at the sites is basically identical, and, thus, the drawing object to be displayed on the screen is also basically the same for the sites and is displayed in a state which allows the drawing object to be edited. In other words, the drawing object is in a shared state. The attribute of “unshared” cancels this shared state and limits a process to be applied to the drawing object at the other sites.

The situation of the conference participant will first be described. In FIG. 5A, two drawing objects 41 and 42 are displayed at all sites. In each drawing in the exemplary embodiment, a drawing object for which no attribute is set is illustrated surrounded by a solid line such as for the drawing objects 41 and 42 in FIG. 5A. A conference participant at the site A selects an attribute setting mode through, for example, operation of a mode switching switch provided on the electronic pen 12 and points, using the pen, to a display region of the drawing object 42 for which the conference participant wishes to change the setting of the attribute. With this action, a pull-down menu 43 is displayed on the screen. As the pull-down menu 43 contains a list of items of attributes for which the setting can be changed, the conference participant selects a desired attribute from the list; in this case, “unshared”. In each drawing in the exemplary embodiment, the set attribute is illustrated as surrounded by a dotted line such as the “unshared” in the pull-down menu 43 of FIG. 5A. When the conference participant selects “unshared”, the attribute of “unshared” is set for the drawing object 42 which is the setting target of the attribute. As illustrated in FIG. 5B, a display form of the drawing object 42 to which “unshared” is set at the site A is illustrated as being surrounded by a dotted line.

As described, because the drawing object 42 to which “unshared” is set becomes unshared with the other sites, the drawing object which should be displayed as “Regarding Management Environment” is not displayed at the site B as shown in FIG. 5B. In other words, the drawing object 42 is changed to a state in which the object is not shared.

In FIG. 5B, the display of the drawing object 42 at the site B is deleted. The drawing object 42 may alternatively be considered as being displayed in a transparent form. However, because there may be cases in which complete deletion is disadvantageous, in the exemplary embodiment a display form of semitransparency is prepared. More specifically, when the attribute of “unshared” is selected, a submenu 44 is further displayed on the screen. In this manner, it is possible to alternatively allow the conference participant to select whether the drawing object 42 is to be displayed in a transparent manner as shown in FIG. 5B or displayed in a semitransparent manner as shown in FIG. 5D. In FIG. 5D, the text within the drawing object 42 is displayed for convenience.

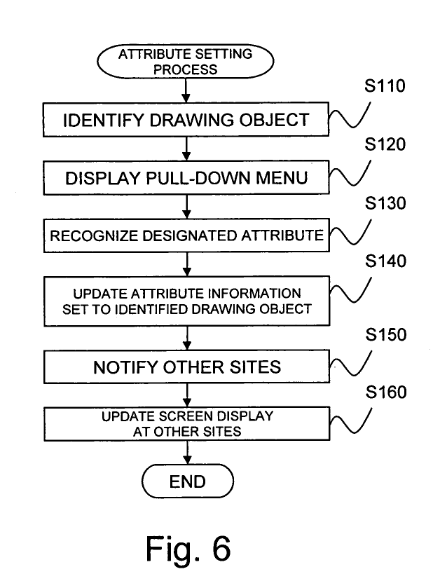

The displayed screen on the touch panel display devices 11 and 21 at the sites are as described above. An operation in the exemplary embodiment for realizing the screen display will now be described. A general operation regarding the attribute setting process in the exemplary embodiment will first be described with reference to the flowchart of FIG. 6 and a specific operation corresponding to FIG. 5 will be described later.

When a conference participant at the site A selects an attribute setting mode, the conference controller 35 starts the attribute designation processor 32. Then, when the conference participant points to the touch panel display device 11 with the pen, the attribute designation processor 32 identifies which drawing object is pointed at, by comparing and matching the pointed position and a display region, of the drawing objects 41 and 42 displayed on the touch panel display device 11, stored in the drawing object information storage 37 (step 110). Then, the pull-down menu 43 is displayed overlapping the identified drawing object (step 120). In the exemplary embodiment, the pull-down menu 43 is displayed overlapping the drawing object for which the attribute is to be set in order to clearly show the drawing object, but the present invention is not limited to displaying the pull-down menu in an overlapping manner, so long as the display can clarify the drawing object for which the attribute is to be set. For example, it is also possible to employ a configuration in which the display attribute such as display color and brightness of the drawing object for which the attribute is to be set is changed to differ from those of the other drawing objects.

When the conference participant selects one of the attributes from among the attributes in the pull-down menu 43, the attribute designation processor 32 identifies the selected attribute (step 130). This can be recognized through comparison and matching of the position of the tip of the electronic pen 12 and the displayed position of the attribute name within the pull-down menu 43. When a submenu 44 is prepared in the selected attribute as exemplified in FIG. 5C, the submenu 44 is displayed and an attribute selected from the submenu 44 is further identified.

When the drawing object for which an attribute is to be set and an attribute to be set for the drawing object are recognized in this manner, the attribute designation processor 32 make the information management section 34 set a content which is set with respect to a selected attribute among the attribute information of the drawing object stored in the drawing object information storage 37 (step 140). In this manner, the attribute information is updated with the content which is set with respect to the drawing object. The specific content of the information to be set differs depending on the selected attribute, and, thus, the details of the content of the setting will be described later.

When the content of stored information related to the drawing object is changed, the attribute notification processor 33 notifies the updated content to other sites (step 150). The screen data process controller 24 of the notified site updates display with respect to the drawing object according to the notified content as necessary (step 160).

Next, a more specific operation will be described for a case in which the attribute to be set is “unshared” as explained with reference to FIG. 5.

When the conference participant at the site A designates the drawing object 42 and the attribute “unshared” to be set for the drawing object 42 on the touch panel display device 11 through an operation of the electronic pen 12 (steps 110-130), the attribute designation processor 32 sets, in the information management section 34, the information related to “unshared” among the attribute information of the drawing object 42 stored in the drawing object information storage 37 (step 140). The value to be set to the attribute may basically be flag information if the value indicates whether or not the drawing object is to be unshared. However, in the exemplary embodiment, when the drawing object is unshared, it is necessary to also set information of transparent or semitransparent. Therefore, for example, an attribute value of 0 indicating that “unshared” is not set is set when the drawing object is not unshared (that is, when the drawing object is shared), an attribute value of 1 is set when the drawing object is unshared and is to be displayed in a semitransparent manner, and an attribute value of 2 is set when the drawing object is unshared and is to be displayed in a transparent manner (unshared). The attribute value is not limited to numerical values, and symbols may be used instead. When the attribute designation processor 32 updates the attribute information related to “unshared” which is selected as described above, the attribute notification processor 33 notifies the updated content to the other site B (step 150). The screen data process controller 24 of the notified site B updates the display with respect to the drawing object 42 in accordance with the notified content (step 160). More specifically, when the drawing object is unshared and transparent display is set for the drawing object 42, the screen display is updated as shown in FIG. 5C and, when the drawing object is unshared and semitransparent display is set, the screen display is updated as shown in FIG. 5D. In the exemplary embodiment, the drawing object 42 is displayed unshared in the site A in which the attribute is set and the drawing object 42 is displayed in a transparent manner or a semitransparent manner at the other sites B, depending on the setting. The site at which the attribute is set and the sites other than this site can be determined by the attribute designation server ID which is set and stored in correspondence to the attribute information.

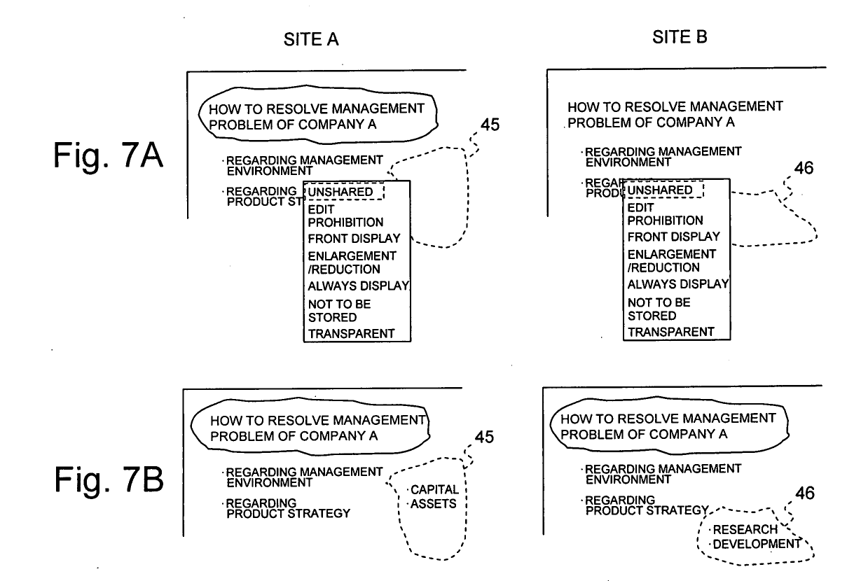

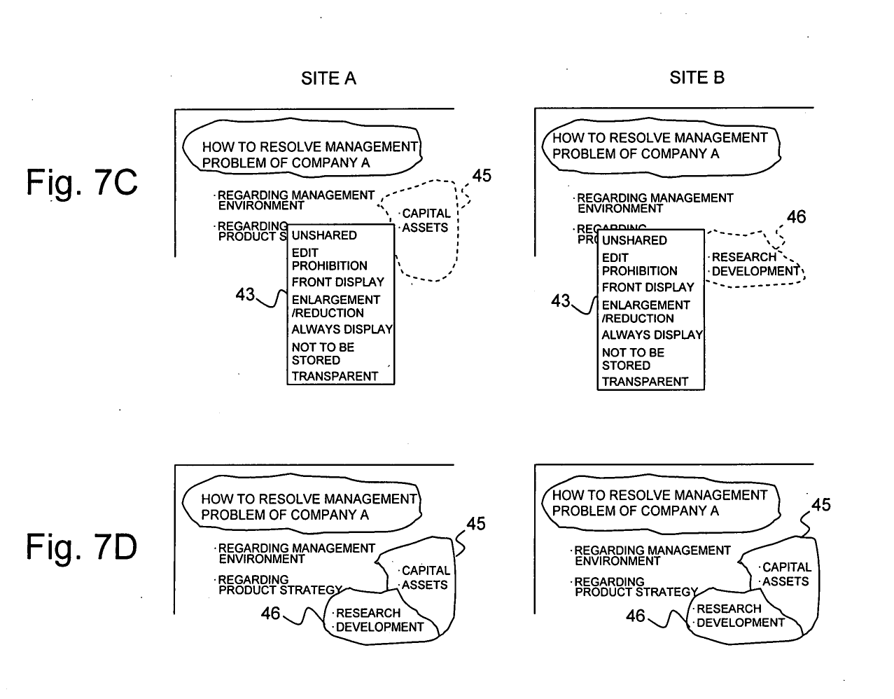

FIG. 7 is a diagram for explaining another form of usage when an attribute of “unshared” is set for a drawing object and shows an example screen display indicating primary portions of the touch panel display devices 11 and 21 at the sites. FIG. 7A shows a case in which drawing objects 45 and 46 are newly created in the sites A and B, respectively, and an attribute of “unshared” (in this example, transparent display) is set for these drawing objects 45 and 46. FIG. 7B shows an example case in which writing is performed in the drawing objects 45 and 46 at the sites A and B, respectively. The conference participants at the sites A and B set the unshared display regions (drawing objects) on the touch panel display device 11 and 21, respectively, of the participant's site (self-site). By the participants writing in the respective drawing objects, it is possible to not display, at the other site, the contents written in the unshared display regions of the touch panel display devices 11 and 21 of the self-site. Therefore, when, for example, discussion needs to take place at each site during a conference common to all sites, it is possible to create an “unshared” display region (drawing object) on the display screen as described above and to write in the unshared display region, to thereby efficiently use the touch panel display devices 11 and 21 for local discussions.

The unshared drawing object can be changed to a shared drawing object. More specifically, the conference participant at the site A can point, with the pen, to the display region of the drawing object 45 after selecting the attribute setting mode so that the pull-down menu 43 is displayed as shown in FIG. 7C and the conference participant at the site A can cancel the selection of “unshared” in the pull-down menu 43. This can be realized by re-selecting the selected “unshared”. When “unshared” is selected, the attribute is cancelled and the display returns to the normal state in which the display content is shared. On the other hand, when a similar operation is applied at the site B, the drawing object 46 can be returned to the normal shared state. Example screen displays at the sites A and B when the objects have returned to the normal shared state are shown in FIG. 7D. Because the screen data process controllers 14 and 24 of the sites A and B synthesize the screen data to be displayed and the drawing object to be displayed with the screen data to create a screen image, the drawing object 45 and the drawing object 46 are displayed in an overlapping manner as exemplified in FIG. 7D. In FIG. 7D, the drawing object 45 is displayed at the front at both the site A and the site B. However, the present invention is not limited to such a configuration, and it is possible to employ a configuration, for example, in which there can be set information which indicates which of the drawing objects is to be displayed in the front or in which the drawing object of the self-site is displayed in the front with priority. As the display region for the drawing object can be set individually, the conference participant can move the display position of a desired drawing object through a predetermined movement operation. For example, a drawing object moving mode may be selected through an operation of a mode switching switch provided on the electronic pen 12, etc., and the drawing object can be moved through a drag-and-paste operation using the electronic pens 12 and 22.

Therefore, for example, when local discussion is conducted at each site during a conference for all sites and it is desired to collect the discussions at the respective sites for discussion for the overall conference, it is possible for all sites to quickly and easily transfer to the conference, by cancelling the attribute setting of the “unshared” display region (drawing object) and returning the state to the shared state as described above.

Setting of other attributes will now be described. The operation in the exemplary embodiment, however, is basically similar to that for the setting of the attribute of “unshared”, and, thus, the display of the drawing object for which the attribute setting is to be changed, limitation of the operation, etc. will be described by reference to an example display content on the touch panel display devices 11 and 21.

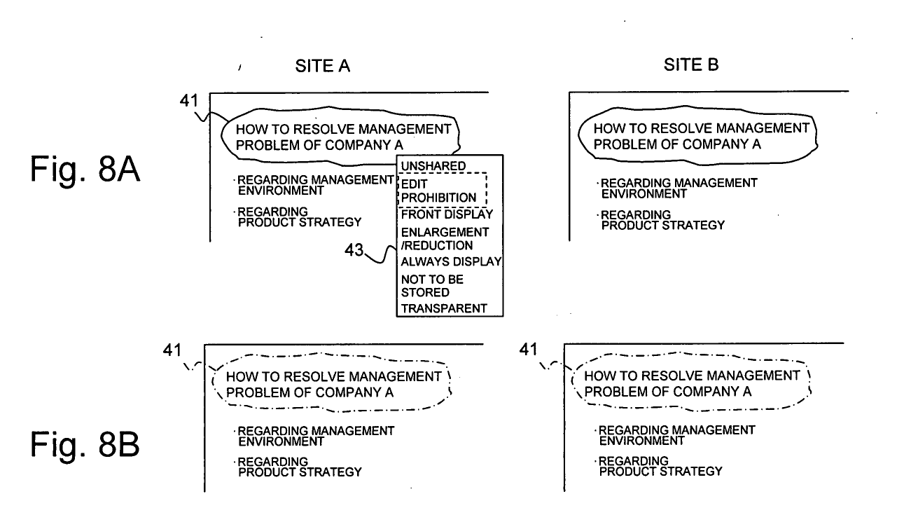

FIG. 8 is a diagram for explaining handling of a drawing object when an attribute of an “edit prohibition” is set for the drawing object and shows an example screen display indicating primary portions on the touch panel display devices 11 and 21 at the sites. In the exemplary embodiment, the content displayed on the sites is basically identical, writing can be performed from any site to the commonly displayed content, and the commonly displayed content can be edited from any site. This is also true for the drawing object and, in general, writing or editing is possible from any site. In some cases, however, there is a demand for fixing the written content; that is, a demand for prohibiting editing.

In this case, the conference participant at the site A selects the attribute setting mode, and, then points, with the pen, to the display region of the drawing object 41 for which the setting of the attribute is to be changed, so that the pull-down menu 4.3 is displayed on the screen as shown in FIG. 8A. Then, the conference participant selects a desired attribute; here, “edit prohibition”, from the pull-down menu 43. When the conference participant selects “edit prohibition”, the attribute of the “edit prohibition” is set for the drawing object 41 which is the setting target. In the attribute of “edit prohibition”, whether or not editing is prohibited is set, and, thus, the attribute value to be set may be flag information. As exemplified in FIG. 8B, a display form of the drawing object 41 for which “edit prohibition” is set at the site A is shown surrounded by a dot-and-chain line. As the setting of “edit prohibition” is notified to the other site B, the line showing the display region of the drawing objects 41 at the other sites is also changed to the dot-and-chain line, as illustrated in FIG. 8B with respect to the site B.

Similar to the case of “unshared”, by re-displaying the pull-down menu 43 and re-selecting “edit prohibition” in the pull-down menu 43, it is possible to cancel the attribute setting of the “edit prohibition”.

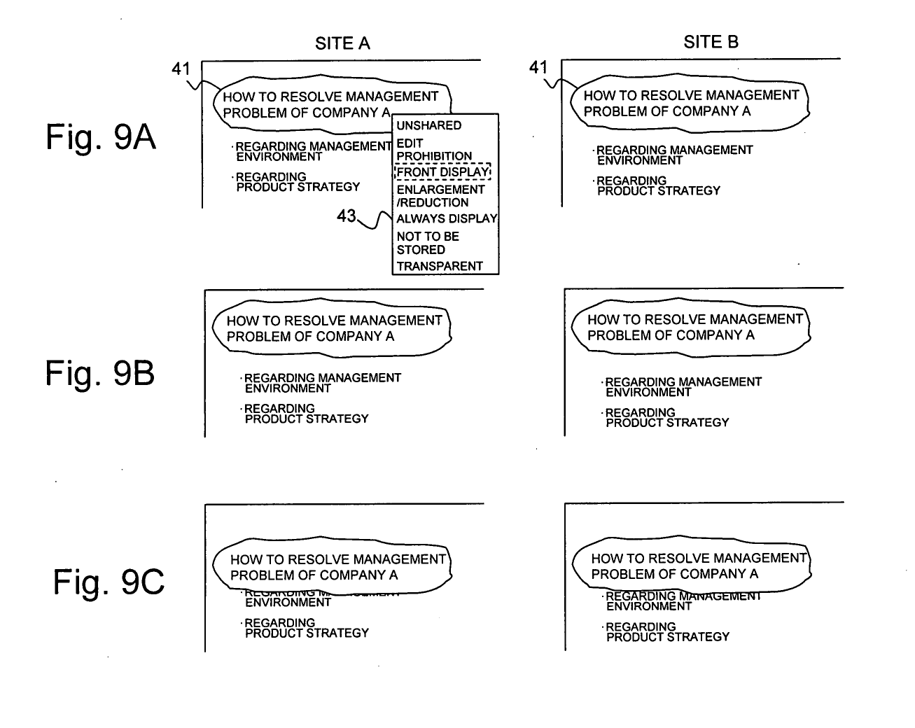

FIG. 9 is a diagram for explaining handling of a drawing object when an attribute of “front display” is set for the drawing object. An overlapped display of display contents has already been described with respect to FIG. 7D. Here, it is possible to explicitly instruct display at the front by means of the attribute setting.

In such a case, a conference participant at the site A selects an attribute setting mode and points, with the electronic pen 12, to the display region of the drawing object 41 for which the attribute setting is to be changed so that the pull-down menu 43 is displayed on the screen as shown in FIG. 9A. Then, the conference participant selects a desired attribute; here, “front display”, from the pull-down menu 43. When the conference participant selects “front display”, the attribute of “front display” is set for the drawing object 41 which is the setting target. In the attribute of “front display”, whether or not the drawing object is to be displayed in front of the other display is set, and, thus, the attribute value to be set may be flag information. However, because there is a possibility that the attribute of “front display” is set for each of the drawing objects displayed in an overlapped manner, it is desirable to set, in the attribute value, additional information which forms a basis for determination of which of the objects is to be displayed in the front, such as priority, setting order, time of setting of the attribute, etc., in consideration of such a case.

Because the change of the attribute of the drawing object 41 by the setting of “front display” at the site A is notified to the other site B, the attribute of the drawing object 41 at the other site B is also changed to “front display”. A display state at this point is shown in FIG. 9B. When the conference participant selects a drawing object movement mode and moves the drawing object 41 in a downward direction through a predetermined operation, the drawing object 41 is displayed in front of the other display contents as illustrated in FIG. 9C.

Similar to the case of “unshared”, the attribute setting of the “front display” can be cancelled by re-displaying the pull-down menu 43 and re-selecting “front display” in the pull-down menu 43.

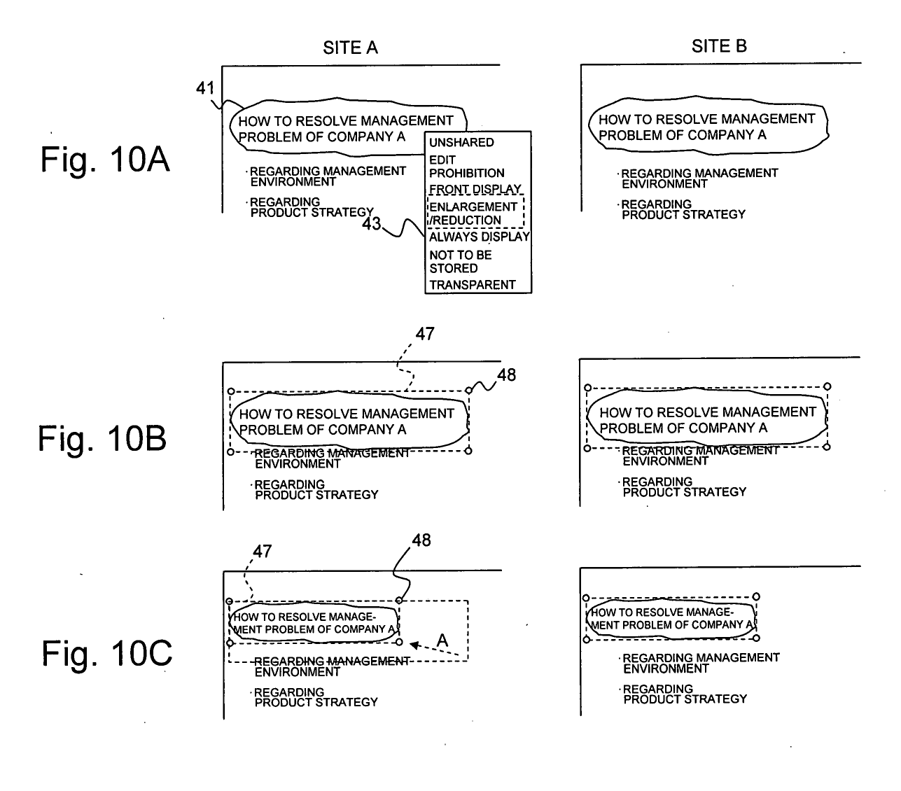

FIG. 10 is a diagram for explaining handling of a drawing object when an attribute of “enlargement/reduction” is set for the drawing object. A drawing object to which the attribute of “front display” is set is displayed in front when display contents overlap. There may be cases, however, where the display in the overlapping state is to be cancelled or the text is to be displayed in an enlarged manner. Thus, in the exemplary embodiment, the display size of the drawing object can be enlarged and reduced.

A conference participant at the site A selects the attribute setting mode and points, with the electronic pen 12, to the display region of the drawing object 41 for which the attribute setting is to be changed so that the pull-down menu 43 is displayed on the screen as shown in FIG. 10A. Then, the conference participant selects a desired attribute; here, “enlargement/reduction”, from the pull-down menu 43. When the conference participant selects “enlargement/reduction”, a quadrangular frame 47 surrounding the drawing object 41 which is the setting target is displayed, and a size change button 48 is displayed at each corner of the frame 47 for arbitrarily changing the display size of the drawing object 41. The display state at this point is shown in FIG. 10B. The conference participant places the tip of the electronic pen 12 on one of the size change buttons 48 and, through a drag-and-drop operation in the direction of an arrow A, changes the size of the frame 47. The display size of the drawing object 41 is changed in accordance with the change of the size of the frame 47. FIG. 10C shows an example in which the drawing object 41 is reduced and displayed.

The attribute value which is set to the drawing object information storage 37 when the attribute “enlargement/reduction” is set, for example, by updating display region information or setting a magnification to the attribute information in addition to a flag value indicating that the attribute is set for the attribute information. In the exemplary embodiment, in general, a configuration is considered in which the objects are displayed in all sites with the same display size, and, thus, the information related to the drawing object is constructed as shown in FIG. 3 and the attribute information is common to all sites. However, the present invention is not limited to such a configuration, and it is also possible to construct data to allow setting of the attribute information at each site in order to enable setting of different display sizes individually for multiple sites.

Similar to the case of “unshared,” the attribute setting of “enlargement/reduction” can be cancelled by re-displaying the pull-down menu 43 and re-selecting “enlargement/reduction” in the pull-down menu 43. After this process, the drawing object 41 is displayed with the original display size.

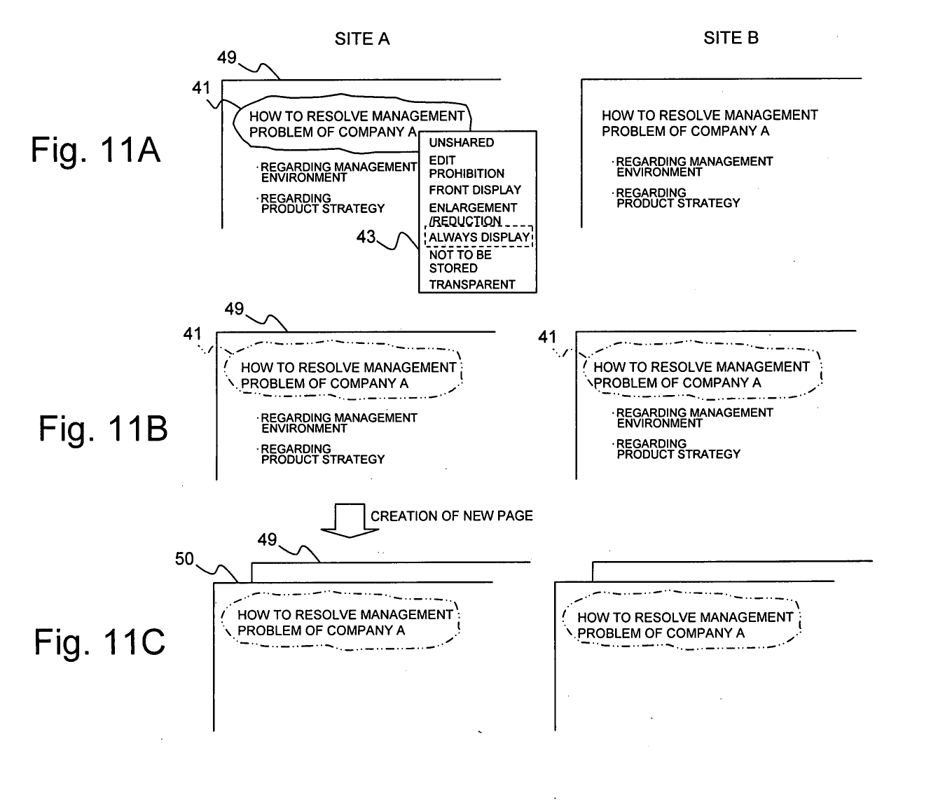

FIG. 11 is a diagram for explaining handling of a drawing object when an attribute of “always display” is set for the drawing object. A conference participant at the site A selects the attribute setting mode and points, with the electronic pen 12, to the display region of the drawing object 41 for which the attribute setting is to be changed in a displayed drawing image 49 so that the pull-down menu 43 is displayed on the screen as shown in FIG. 11A. Then, the conference participant selects a desired attribute; here, “always display”, from the pull-down menu 43. When the conference participant selects “always display”, an attribute of “always display” is set for the drawing object 41 which is the setting target. In the attribute of “always display”, whether or not the object is to be always displayed is set, and, thus, the attribute value to be set may be flag information. As exemplified in FIG. 11B, a display form of the drawing object 41 for which “always display” is set at the site A is shown surrounded by a two-dot-and-chain line. As the setting of “always display” is notified to the other site B, the line showing the display region of the drawing object 41 at the other site is also changed to a two-dot-and-chain line, as shown in the display screen example at the site B shown in FIG. 11B.

FIG. 11C shows an example display screen when a screen image 50 is newly created and displayed using an existing creation function of a new page (blank paper function) provided by the electronic conference system. As shown in the screen image 50 of the newly created page, the drawing object 41 for which the attribute of “always display” is set is synthesized with the image data of blank paper and displayed on the screen. Therefore, as exemplified in FIG. 11C, the drawing object 41 is automatically displayed also on the newly created page. With this process, for example, items that are desired to be always displayed, such as the agenda of the conference, can be always displayed on the screen even when the page to be displayed is updated.

Similar to the case of “unshared”, the attribute setting of “always display” can be cancelled by re-displaying the pull-down menu 43 and re-selecting “always display” in the pull-down menu 43. With this process, the drawing object 41 will not be displayed on newly created pages.

The pull-down menu 43 includes an attribute of “not to be stored”. In general, for a drawing object, information is stored in the drawing object information storage device 37. However, when the attribute of “not to be stored” is set, the information related to the drawing object for which the attribute is set can be made an exception in relation to storage in the drawing object information storage device 37. In this manner, it is possible to not record, for example, display contents that are not necessary to be stored, such as scratched notes on the touch panel display device 11 and display contents not to be shared with the other sites. Similar to the case of “unshared”, the attribute setting of “not to be stored” can be cancelled by re-selecting the attribute.

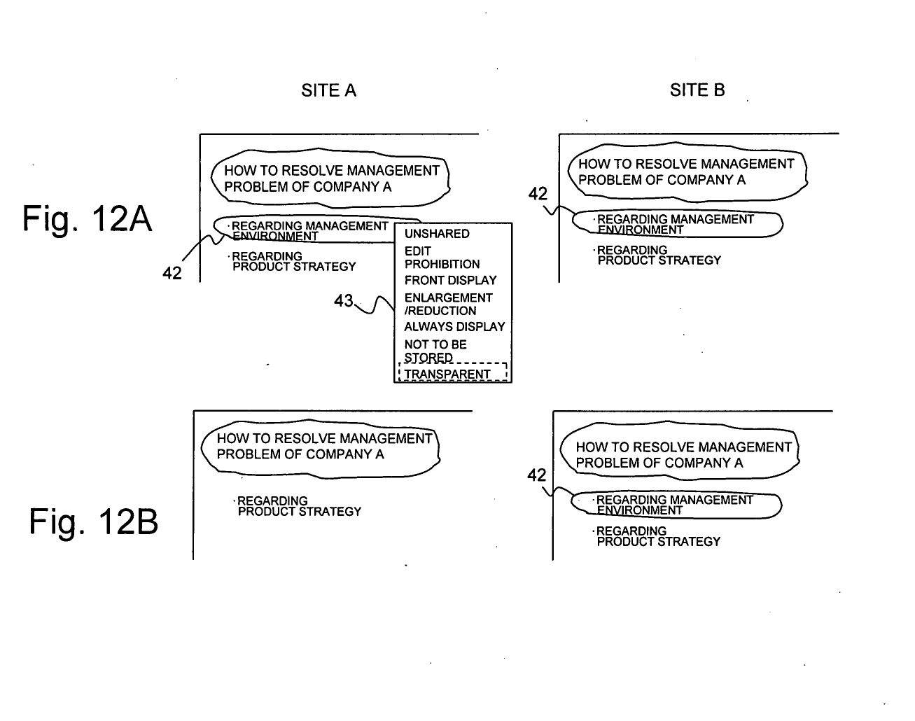

FIG. 12 is a diagram for explaining handling of a drawing object when an attribute of “transparent” is set for the drawing object. In short, the attribute of “transparent” is an attribute which is opposite the attribute of the above-described “unshared,” which makes the object to be not displayed on the touch panel display device 21 of the other site B, and the attribute of “transparent” makes the object to be not displayed on the touch panel display device 11 of the self-site A. Specifically, the conference participant at the site A selects the attribute setting mode and points, with the electronic pen 12, to the display region of the drawing object 42 for which the attribute setting is to be changed, so that the pull-down menu 43 is displayed on the screen as shown in FIG. 12A. Then, the conference participant selects a desired attribute; here, “transparent”, from the pull-down menu 43. When the conference participant selects “transparent”, an attribute of “transparent” is set for the drawing object 42, which is the setting target. In the attribute of “transparent”, whether or not the object is to be displayed in transparent (unshared) is set, and, thus, the attribute value to be set may be flag information. As shown in FIG. 12B, the drawing object for which “transparent” is set in the site A disappears from the touch panel display device 11. Meanwhile, although the screen data process controller 24 of the other site B receives a notification of setting of attribute of “transparent” to the drawing object 42, because the display content does not need to be changed in the case of this attribute, the display content on the touch panel display device 21 is unchanged. In this manner, by deleting unnecessary display contents from the screen, it is possible to secure a writing space on the screen.

As an operation to cancel the setting of the attribute, a process is described above in which the drawing object for which the attribute is set is selected, the pull-down menu 43 is displayed, and the corresponding attribute is re-selected from the pull-down menu 43, with respect to the above-described attributes. In the case of the attribute of “transparent”, however, because the corresponding drawing object is displayed in transparent; that is, the corresponding drawing object is in the unshared state, the drawing object cannot be selected on the screen in an operation similar to that for the other attributes. Therefore, a configuration is employed, for example, in which the display region of the drawing object which is displayed in transparent or a quadrangular frame surrounding the drawing object is dimly displayed so that the object does not hinder other writings and, at the same time, the setting can be cancelled through an operation similar to those for the other attributes. Alternatively, it is also possible to employ a configuration in which an indicator is displayed in a predetermined region on the screen indicating that there is a drawing object for which the attribute of “transparent” is set and the attribute setting is cancelled by selecting the indicator. In this manner, by providing means for cancelling the attribute setting of “transparent”, it is possible to cancel the attribute setting of “transparent” in a manner similar to that for the other attributes.

In the exemplary embodiment, as shown in FIG. 2, the screen data information storage 36 and the drawing object information storage 37 are provided in the conference information management server 30 to manage the drawing objects created at the sites and totally control the displays on the touch panel display devices 11 and 21 provided at the sites, such as notification of change of attribute setting at each site to the other sites. The overall structure of the system, however, is not limited to such a configuration. For example, it is also possible to provide the constituent elements 31-37 to each of the conference servers 10 and 20, so that the screen control at the self-site is individually executed and the conference information management server 30 executes sharing and synchronizing processes for matching the information stored and managed individually by the conference servers 10 and 20.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic conference system comprising:
a plurality of conference servers to which a display is connected, and
an electronic conference control device, wherein
the conference server comprises:
an attribute acquiring unit that acquires attribute information which is designated with respect to a drawing object contained in a screen image displayed on the connected display;
a screen data process controller that processes the drawing object in accordance with the acquired attribute information; and
an attribute information transmitting unit that transmits the acquired attribute information to the electronic conference control device, and
the electronic conference control device comprises:
a screen data management unit that manages information related to screen image commonly displayed on the plurality of displays;
a drawing object management unit that manages a portion of a screen image as a drawing object;
an attribute designation processor that receives attribute information transmitted from the attribute information transmitting unit of one of the plurality conference servers; and
an attribute notification processor that notifies the received attribute information with respect to the drawing object to a conference server other than the conference server in which the attribute information is designated.

2. A conference server comprising:
an attribute acquiring unit that acquires attribute information which is designated with respect to a drawing object contained in a screen image displayed on a display which is connected to the conference server;
a screen data process controller that processes the drawing object in accordance with the attribute information acquired by the attribute acquiring unit; and
an attribute information transmitting unit that transmits the attribute information acquired by the attribute acquiring unit to an electronic conference control device.

3. An electronic conference control device comprising:
a screen data management unit that manages information related to screen image commonly displayed on display devices;
a drawing object management unit that manages a portion of a screen image as a drawing object;
an attribute designation processor that receives attribute information which is designated by a user with respect to the drawing object; and
an attribute notification processor that notifies the received attribute information with respect to the drawing object to a conference server other than the conference server in which the attribute information is designated.

4. The electronic conference control device according to claim 3, further comprising:
a drawing object creation processor that creates the drawing object based on a screen image contained in a region formed by a user operation on a screen image displayed on one of the plurality of displays.

5. A computer readable medium storing a program causing a computer to execute a process for supporting an electronic conference, the process comprising:
acquiring attribute information which is designated with respect to a drawing object contained in a screen image displayed on a display which is connected to the computer;
processing the drawing object according to the acquired attribute information; and
transmitting the acquired attribute information to an electronic conference control device.

6. A computer readable medium storing a program causing a computer to execute a process for supporting an electronic conference, the process comprising:
managing information related to screen image commonly displayed on a plurality of displays connected to a plurality of conference servers in the electronic conference;
managing a portion of a screen image as a drawing object,;
receiving attribute information which is designated with respect to the drawing object; and
notifying the received attribute information with respect to the drawing object to a conference server other than the conference server in which the attribute information is designated.

7. The computer readable medium according to claim 6, wherein
the process further comprises:
creating the drawing object based on a screen image contained in a region formed by a user operation on a screen image displayed on one of the displays.

8. A computer readable medium according to claim 5, wherein
the process further comprises:
acquiring, when information related to a managed drawing object includes identification information of the drawing object, display region of the drawing object on a screen image, and attribute information of the drawing object, attribute information for processing the drawing object.

9. The computer readable medium according to claim 5, wherein
the attribute information includes one of information on whether or not the drawing object is to be shared, information on whether or not the drawing object can be edited, information on whether or not the drawing object is to be displayed, information on whether or not the drawing object is to be displayed in front, information on whether or not the drawing object is to be always displayed, information on whether or not the drawing object can be stored, and enlargement/reduction information of display.

10. The computer readable medium according to claim 6, wherein
the attribute information includes one of information on whether or not the drawing object is to be shared, information on whether or not the drawing object can be edited, information on whether or not the drawing object is to be displayed, information on whether or not the drawing object is to be displayed in front, information on whether or not the drawing object is to be always displayed, information on whether or not the drawing object can be stored, and enlargement/reduction information of display.

11. An electronic conference supporting method comprising:
causing a conference server included in an electronic conference system and to which a display is connected, to:
acquire attribute information which is designated with respect to a drawing object contained in a screen image displayed on the display which is connected to the conference server; and
transmit the acquired attribute information to an electronic conference control device, and
causing an electronic conference control device included in the electronic conference system to:
receive attribute information transmitted from one of conference servers; and
notify the received attribute information with respect to the drawing object to a conference server computer other than the conference server computer in which the attribute information is designated; wherein
the conference server receiving the notification of attribute information processes the drawing object in accordance with the notified attribute information.

12. A computer data signal embodied in a carrier wave for enabling a computer to perform a process for supporting an electronic conference, the process comprising:
acquiring attribute information which is designated with respect to a drawing object contained in a screen image displayed on a display which is connected to the computer;
processing the drawing object in accordance with the acquired attribute information; and
transmitting the acquired attribute information to an electronic conference control device.

13. A computer data signal embodied in a carrier wave for enabling a computer to perform a process for supporting an electronic conference, the process comprising:
managing information related to screen image commonly displayed on a plurality of displays connected to a plurality of conference servers in an electronic conference system;
managing a portion of a screen image as a drawing object;
receiving attribute information which is designated with respect to the drawing object, and notifying the received attribute information with respect to the drawing object to a conference server other than the conference server in which the attribute information is input and designated.
